(19) United States
(12) Patent Application Publication
(10) Pub. No.: US 2012/0263549 A1
(43) Pub. Date: Oct. 18, 2012

(54) GEAR MACHINING MACHINE

(75) Inventors: Satoru Akama, Minato-ku (JP); Seisaku Odan, Minato-ku (JP)

(73) Assignee: MITSUBISHI HEAVY INDUSTRIES, LTD., Tokyo (JP)

(21) Appl. No.: 13/504,903

(22) PCT Filed: Apr. 21, 2010
(86) PCT No.: PCT/JP2010/057060

§ 371 Date: Jul. 6, 2012

(30) Foreign Application Priority Data
Dec. 4, 2009 (JP) 2009-276208

(51) Int. Cl. B23F 1/00; B23Q 1/48

(52) U.S. Cl. 409/50

(57) ABSTRACT

A gear machining machine has a cutter head with improved rigidity. The machine is equipped with a movement base that is movably supported and rotatably supports a rotation table on which an external gear or an internal gear is mounted; a bridge section of a gate-shaped column provided at a location above the movement base; a saddle which is supported by the bridge section in a vertically movable manner; and a cutter head on the front surface of the saddle, the lower end of which rotatably supports a tool. A protrusion which projects forward is provided on the front surface of the cutter head. The tool is disposed so that the front thereof protrudes further forward of an end surface which is the most forward projecting portion of the protrusion.

### TECHNICAL FIELD

The present invention relates to a gear machining machine which is capable of cutting an external gear and an internal gear by use of a single cutter head.

### BACKGROUND ART

Gears include external gears and internal gears. Conventionally, separate gear machining machines have been used respectively for the machining of an external gear and the machining of an internal gear, or alternatively, a single gear machining machine has been used for both. In order to machine both of an external gear and an internal gear with a single gear machining machine, a machining head dedicated to external gears needs to be used for machining the external gear while a machining head dedicated to internal gears needs to be used for machining the internal gear. For this reason, the conventional gear machining machine requires an operation to replace the machining head when machining one of the external gear and the internal gear and then machining the other.

In the meantime, a gear grinding machine capable of grinding external gears and internal gears by using a single grinding head has been provided in recent years. Such a conventional gear grinding machine is disclosed in Patent Document 1, for example.

### PRIOR ART DOCUMENT

### Patent Document

Patent Document 1: Japanese Patent Application Publication No. Hei 10-151523

### SUMMARY OF THE INVENTION

### Problems to be Solved by the Invention

In order to eliminate the need for a head replacement operation at the time of switching a grinding workpiece between an external gear and an internal gear, the above-described conventional gear grinding machine is configured such that: a grinding head is formed into an L shape in a side view, including a horizontally extending portion extending in a horizontal direction and a pendulous portion extending downward from a front end of this horizontally extending portion; and a grinding wheel is supported rotatably at a lower end of the pendulous portion.

However, it is difficult to ensure rigidity of the pendulous portion in the above-described configuration of the grinding head. Therefore, run-out of the grinding wheel may occur due to a machining load (cutting reaction force) during grinding and may degrade machining accuracy.

In addition, according to the conventional grinding method, in a case of grinding an external gear, a front of the grinding wheel is brought into contact with the external gear. In a case of grinding an internal gear, a rear of the grinding wheel is brought into contact with the internal gear. Thus, a direction of application of a machining load during the grinding of the external gear is opposite to a direction of application of a machining load during the grinding of the internal gear. Moreover, since the grinding head has the L shape, the magnitude of the machining load during the grinding of the external gear is different from the magnitude of the machining load during the grinding of the internal gear. Hence, there may be variations in machining accuracy between the external gear and the internal gear.

Furthermore, in a case of grinding an internal gear having a large diametric dimension difference between an inside diameter dimension and an outside diameter dimension, it is necessary to increase the length of the horizontally extending portion of the grinding head. This may cause a further decrease in the rigidity of the grinding head.

Meanwhile, in the manufacturing of an external gear and an internal gear, tooth profiles thereof are formed by performing gear cutting (cutting) before grinding tooth surfaces. Here, the machining load (cutting reaction force) during gear cutting is much greater than the machining load during grinding. Accordingly, the aforementioned problem becomes more conspicuous if the configuration of the above-described cutting head is applied to a cutter head of the gear machining machine for gear cutting.

Therefore, the present invention has been made to solve the aforementioned problems, and an object thereof is to provide a gear machining machine which is capable of improving rigidity of a cutter head, and of improving machining accuracy and achieving uniform quality in the machining any of an external gear and an internal gear.

### Means for Solving the Problems

A gear machining machine according to a first invention for solving the aforementioned problems is characterized in that

the gear machining machine comprises:
a movement base configured to support a rotation table on which any one of a machining target external gear and a machining target internal gear is to be mounted, the rotation table being supported rotatably around a central axis of the any one of the machining target external gear and the machining target internal gear, the movement base being supported movably in a direction perpendicular to a direction of the central axis;
a support body provided above the movement base;
a saddle vertically movably supported by the support body; and
a cutter head provided on a front surface of the saddle and configured to rotatably support a rotating tool at a lower end thereof,

a protrusion projecting forward is provided on a front side of the cutter head, and

the rotating tool is disposed in such a way that a front thereof protrudes further forward beyond an end portion being the most forward projecting portion of the protrusion.

A gear machining machine according to a second invention for solving the aforementioned problems is characterized in that

the support body is a bridge section of a gate-shaped column disposed to straddle a moving direction of the movement base.

A gear machining machine according to a third invention for solving the aforementioned problems is characterized in that

the cutter head is turnably supported by the saddle.

### Effect of the Invention

Therefore, with the gear machining machine according to the present invention, it is possible to improve rigidity of the cutter head by: providing the protrusion projecting forward on the front side of the cutter head that is provided on the front surface of the saddle; and disposing the rotating tool in such way that the front thereof protrudes further forward beyond the end portion being the most forward projecting portion of the protrusion. Hence, it is possible to improve machining accuracy and achieve uniform quality in the machining of any of the external gear and the internal gear.

### BRIEF DESCRIPTION OF THE DRAWINGS

FIG. 1 is a perspective view of a gear machining machine according to an embodiment of the present invention.

FIG. 2 is an enlarged view of a cutter head.

FIG. 3 is a view showing a turned state of the cutter head.

FIG. 4 is a view showing how gear cutting is performed on an external gear.

Part (a) of FIG. 5 is a sectional side view of FIG. 4, and Part (b) of FIG. 5 is a plan view of FIG. 4.

FIG. 6 is a view showing how gear cutting is performed on an internal gear.

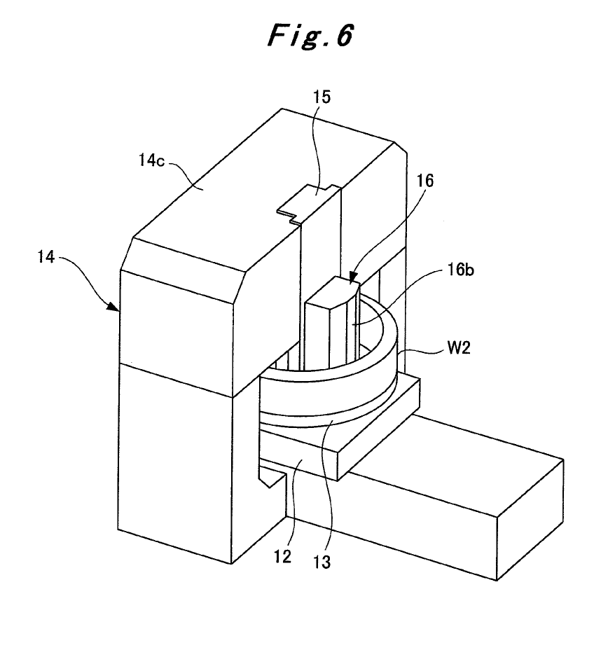

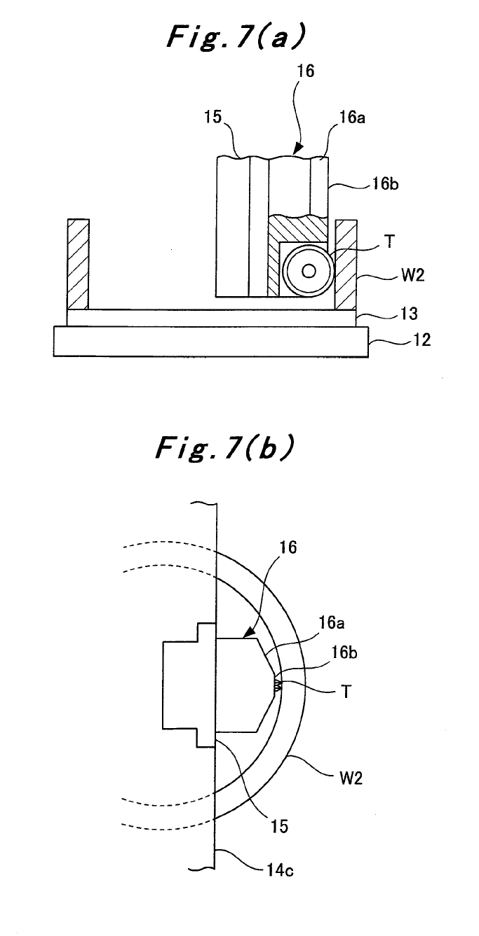

Part (a) of FIG. 6 is a sectional side view of FIG. 6, and Part (b) of FIG. 7 is a plan view of FIG. 6.

### MODE FOR CARRYING OUT THE INVENTION

A gear machining machine according to the present invention will be described below in detail by using the drawings.

### Embodiment

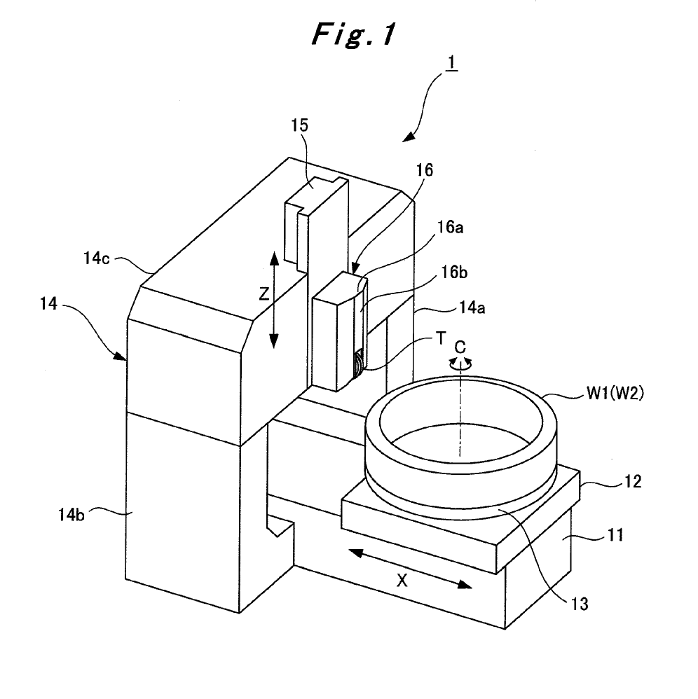

As shown in FIG. 1, a gate-shaped gear machining machine 1 is provided with a bed 11. A movement base 12 is supported on this bed 11 movably in a horizontal x axis direction. A circular rotation table 13 is supported on an upper portion of the movement base 12 rotatably around a vertical workpiece rotating axis C, and either an external gear (machining target external gear) W1 or an internal gear (machining target internal gear) W2 can be selectively mounted on an upper surface of this rotation table 3.

Meanwhile, a gate-shaped column 14 is provided on a rear end side of the bed 11. This gate-shaped column 14 includes a pair of left and right column portions 14a and 14b provided upright at both of left and right sides of the bed 11, and a bridge section (support body) 14c disposed to connect upper ends of these column portions 14a and 14b to each other. Moreover, the bridge section 14c is disposed above the external gear W1 or the inner gear W2 mounted on the rotation table 13, and is provided to straddle the bed 11 extending in the x axis direction, i.e., to straddle a moving direction of the movement base 12 (rotation table 13).

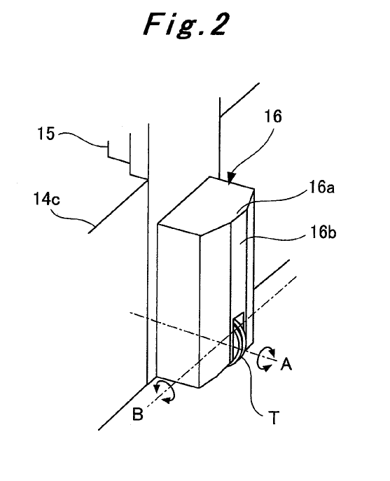

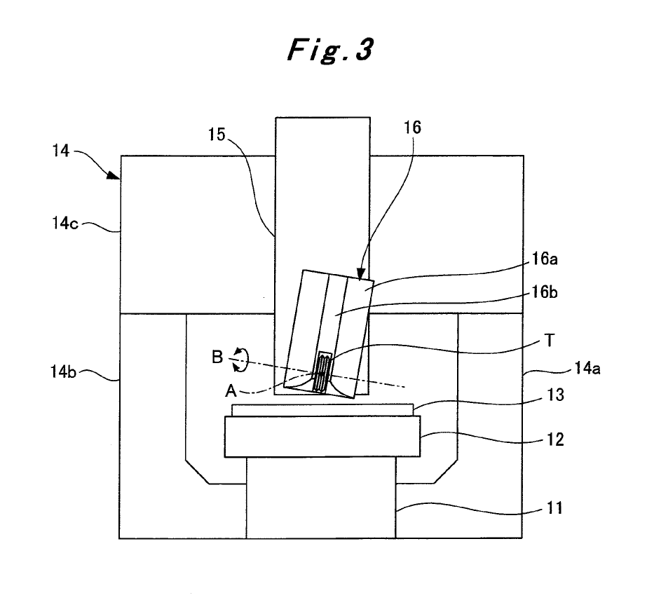

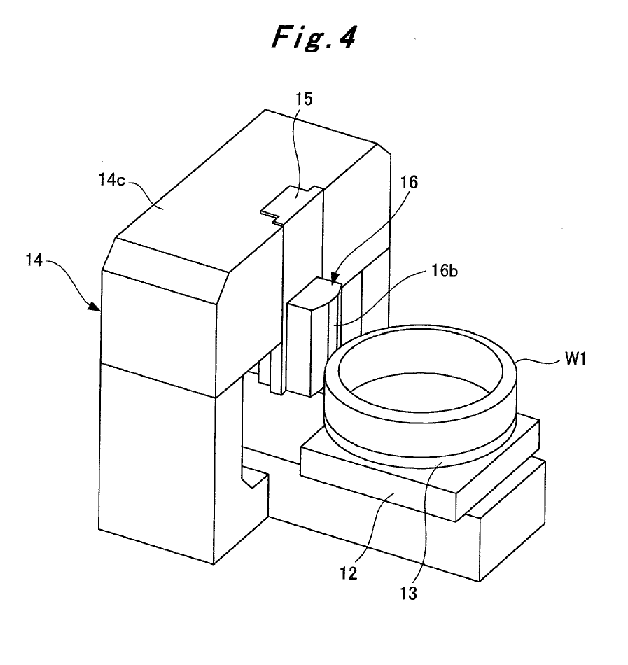

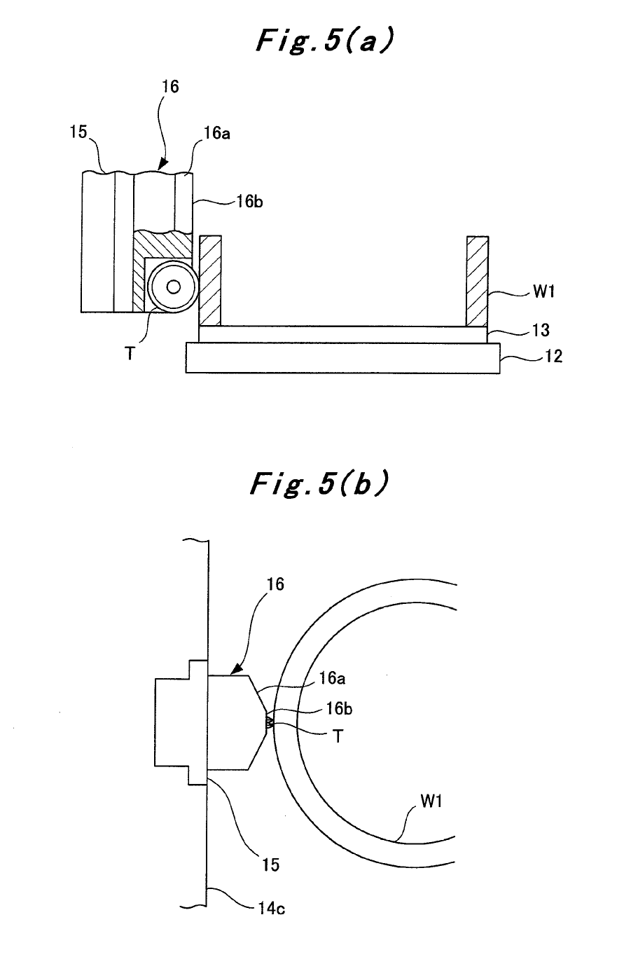

A saddle 15 is supported on a central portion, in a width direction, of the front side of the bridge section 14c movably in a vertical z axis direction. A cutter head 16 is supported on a front surface of this saddle 15 through an unillustrated turning mechanism turnably around a horizontal tool turning axis A. Note that an entire rear surface (entire rear area) of the cutter head 16 is fitted to be closely attached to the front surface of the saddle 16 without any gap therebetween even in the presence of the turning mechanism. Meanwhile, the tool turning axis A is arranged to perpendicularly cross a tool rotating axis B of a later-described tool (rotation tool) T at the center of the tool T (see FIG. 2 and FIG. 3).

Here, as shown in FIG. 1 and FIG. 2, the cutter head 16 has a tubular shape, and a convex protrusion 16a that projects forward is formed on a front side thereof. A front surface of this protrusion 16a is formed into a polygonal shape, and an end surface (end portion) 16b that projects most forward is formed at a central portion, in a width direction, of the front surface. Meanwhile, a tool T such for example as an involute milling cutter is provided inside a lower end of the cutter head 16 rotatably around the tool rotating axis B extending in a perpendicular direction to the x axis direction and the z axis direction. This tool T is disposed in such way that a front thereof protrudes further forward beyond the end surface 16b.

Note that in the above-described embodiment, the front surface of the protrusion 16a is caused to project in the polygonal shape and the front of the tool T is caused to project further forward beyond the end surface 16b. Instead, it is also possible to cause the front surface of the protrusion 16a to project in a circular shape and to cause the front of the tool T to project further forward beyond the end surface. Moreover, an amount of projection of the front surface as well as a degree of curvature, a diametric dimension, and the like of the protrusion 16a are set up based on an outside diameter of the external gear W1 and an inside diameter of the internal gear W2 to be subjected to gear cutting, so that the front surface of the protrusion 16a is prevented from coming into contact with an outer circumferential surface (external teeth) of the external gear W1 or with an inner circumferential surface (internal teeth) of the internal gear W2 during the gear cutting.

Next, gear cutting by the gear machining machine 1 will be described by using FIG. 3 to FIG. 7.

First, in a case of gear cutting of the external gear W1 into a spur gear, the external gear W1 is fixed to the rotation table 13, and then the movement base 12 is moved to an external gear machining position in front of the cutter head 16, as shown in FIG. 4 and FIG. 5. Subsequently, the cutter head 16 is moved down through the saddle 15 to bring the front of the tool T into contact with the outer circumferential surface of the external gear W1. Then, the outer circumferential surface of the external gear W1 is subjected to gear cutting by moving the cutter head 16 up and down through the saddle 15 while rotating the tool T. In this way, a spur gear tooth profile is formed in the outer circumferential surface of the external gear W1 by performing, a predetermined number of times, the above-described gear cutting operation using the tool T while index-rotating the rotation table 13 by an amount equivalent to one tooth space.

Meanwhile, in a case of gear cutting of the external gear W1 into a helical gear, the cutter head 16 is turned at a predetermined angle on the basis of a helix angle of the helical gear as shown in FIG. 3, and then the cutter head 16 is moved down through the saddle 15 to bring the front of the tool T into contact with the outer circumferential surface of the external gear W1 disposed in the external gear machining position. Subsequently, the outer circumferential surface of the external gear W1 is subjected to gear cutting by moving the cutter head 16 up and down through the saddle 15 while rotating the tool T and also rotating the rotation table 13 on the basis of the helix angle to be given to the external gear W1. In this way, a helical gear tooth profile is formed in the outer circumferential surface of the external gear W1 by performing, a predetermined number of times, the above-described gear cutting operation using the tool T while index-rotating the rotation table 13 by an amount equivalent to one tooth space.

Thereafter, in a case of gear cutting of the internal gear W2 into a spur gear, the internal gear W2 is fixed to the rotation table 13 without replacing the cutter head 16, and then the movement base 12 is moved to an internal gear machining position below the bridge section 14c, as shown in FIG. 6 and FIG. 7. Subsequently, the cutter head 16 is moved down through the saddle 15 to bring the front of the tool T into contact with the inner circumferential surface of the internal gear W2. Then, the inner circumferential surface of the internal gear W2 is subjected to gear cutting by moving the cutter head 16 up and down through the saddle 15 while rotating the tool T. In this way, a spur gear tooth profile is formed in the inner circumferential surface of the internal gear W2 by performing, a predetermined number of times, the above-described gear cutting operation using the tool T while index-rotating the rotation table 13 by an amount equivalent to one tooth space.

Meanwhile, in a case of gear cutting of the internal gear W2 into a helical gear, the cutter head 16 is turned at a predetermined angle on the basis of a helix angle of the helical gear as shown in FIG. 3, and then the cutter head 16 is moved down through the saddle 15 to bring the front of the tool T into contact with the inner circumferential surface of the internal gear W2 disposed in the internal gear machining position. Subsequently, the inner circumferential surface of the internal gear W2 is subjected to gear cutting by moving the cutter head 16 up and down through the saddle 15 while rotating the tool T and also rotating the rotation table 13 on the basis of the helix angle to be given to the internal gear W2. In this way, a helical gear tooth profile is formed in the inner circumferential surface of the internal gear W2 by performing, a predetermined number of times, the above-described gear cutting operation using the tool T while index-rotating the rotation table 13 by an amount equivalent to one tooth space.

Note that the above-described gear machining machine 1 performs gear cutting on the external gear W1 and then performs gear cutting on the internal gear W2 without carrying out an operation to replace the cutter head 16. Naturally, it is also possible to perform gear cutting on the internal gear W2 and then perform gear cutting on the external gear W1 without carrying out the operation to replace the cutter head 16.

In the gear machining machine 1 according to the present invention, the cutter head 16 is supported on the saddle 15 in such a way that the entire rear surface of the cutter head 16 faces the front surface of the saddle 15; the protrusion 16a that projects forward is provided on the front side of the cutter head 16; and the tool T is disposed in such way that the front thereof protrudes further forward beyond the end surface 16b which is the most forward projecting portion of the protrusion 16a. Thus, the rigidity of the cutter head 16 can be improved. The improved rigidity makes it possible to suppress run-out of the tool T even if a large machining load is applied to the tool T. Hence, it is possible to achieve improvement in machining accuracy of gear cutting of any of the external gear W1 and the internal gear W2.

In addition, the front of the tool T is always used for gear cutting regardless of which one of the external gear W1 and the internal gear W2 is subjected to the gear cutting. Accordingly, a direction of application of a machining load (cutting reaction force) during gear cutting of the external gear is equal to a direction of application of a machining load (cutting reaction force) during gear cutting of the internal gear. Hence, machining can be performed with the same machining accuracy regardless of which one of the external gear W1 and the internal gear W2 is subjected to the gear cutting. Thereby, uniform quality can be achieved.

Moreover, as the cutter head 16 is supported on the bridge section 14c of the gate-shaped column 14 by way of the saddle 15, it is possible to move the internal gear W2 to the inside of the gate-shaped column 14, i.e., below the bridge section 14c. Hence, it is possible to easily perform gear cutting on the internal gear W2, which has a large diametric dimension difference between an inside diameter dimension and an outside diameter dimension. In this way, it is possible to improve machining accuracy without being constrained by the size of the diametric dimension of the internal gear W2.

Meanwhile, as the cutter head 16 is turnably supported, it is possible to improve machining accuracy and to achieve uniform quality even if any of the external gear W1 and the internal gear W2 is a helical gear.

### INDUSTRIAL APPLICABILITY

The present invention is applicable to a gear machining machine capable of automatically performing a replacement operation between an external gear and an internal gear in the case of machining by use of a single cutter head.

1. A gear machining machine characterized in that
the gear machining machine comprises:
a movement base configured to support a rotation table on which any one of a machining target external gear and a machining target internal gear is to be mounted, the rotation table being supported rotatably around a central axis of the any one of the machining target external gear and the machining target internal gear, the movement base being supported movably in a direction perpendicular to a direction of the central axis;
a support body provided above the movement base;
a saddle vertically movably supported by the support body; and
a cutter head provided on a front surface of the saddle and configured to rotatably support a rotating tool at a lower end thereof,
a protrusion projecting forward is provided on a front side of the cutter head, and
the rotating tool is disposed in such a way that a front thereof protrudes further forward beyond an end portion being the most forward projecting portion of the protrusion.

2. The gear machining machine according to claim 1, characterized in that
the support body is a bridge section of a gate-shaped column disposed to straddle a moving direction of the movement base.

3. The gear machining machine according to claim 1, characterized in that
the cutter head is turnably supported by the saddle.
